(19) United States
(12) Patent Application Publication
(10) Pub. No.: US 2026/0303675 A1
(43) Pub. Date: Oct. 1, 2026

(54) METHODS TO IMPROVE PRESENTATION SHARING IN VIDEO CONFERENCING

(71) Applicant: Adeia Guides Inc., San Jose, CA (US)

(72) Inventors: Tao Chen, Palo Alto, CA (US); Mareeta Mathai, San Jose, CA (US); Christopher Philips, Hartwell, GA (US)

(21) Appl. No.: 19/094,448

(22) Filed: Mar. 28, 2025

(51) Int. Cl. H04L 65/403; H04L 12/18

(52) U.S. Cl. CPC H04L 65/403; H04L 12/1822

(57) ABSTRACT

Systems and methods are provided herein for improving the compression picture quality of shared content in video conferencing while maintaining the flexibility to allow interaction in presentation. In some embodiments, a video conferencing application causes to generate for display, at a receiver device, shared content from a presenter device during a video conference; collects presentation data from the presenter device; causes encoding, at the presenter device, of the presentation data; transmits, to the receiver device, the encoded presentation data; and stores, in a buffer at the receiver device, the encoded presentation data. In some examples, based at least in part on detecting a user interface input at the presenter device, the video conferencing application causes to decode the encoded presentation data stored in the buffer at the receiver device, and causes to generate for display, at the receiver device, the decoded presentation data.

### BACKGROUND

The present disclosure is directed towards techniques for improving presentation sharing in video conferencing.

### SUMMARY

Content sharing in video conferencing is a very common practice. Presentations including PowerPoint (PPT) slides, Word documents, portable document formats (PDFs), spreadsheets, Visio files, image files, audio files, video files, web development files, etc., are examples of shared content at virtual meetings. Many video conferencing apps and systems rely on video compression of shared presentations. When such shared content is subject to video compression and then gets delivered to remote participants, the picture quality of the presentation varies depending on the uplink bandwidth of a sharing participant as well as the downlink bandwidth of a receiving participant. A limited uplink bandwidth often determines the upper bound of the picture quality, regardless of the download bandwidth. Video compression at a low bitrate may degrade the quality, and the degradation usually exhibits the effects of reduced resolution, clarity, definition, etc. of an otherwise high-quality presentation when accessed and opened on a local device.

In one approach, a presenter device shares presentations with the intended receiver devices prior to the video conference, and the receiver devices download the file containing the presentation before joining the video conference. This approach ensures the best quality of such presentations perceived by all participants. However, this approach is not ideal for seamless interaction or control by the presenter, thus creating challenges in maintaining an optimal, synchronized presentation.

In another approach, some applications such as Microsoft's Present Live provide for sharing of a presentation and offer each participant the flexibility of browsing slides in a non-synchronous manner. However, Present Live is not a widely integrated feature except within Microsoft Teams, which has easy access to the core functionality of PPT interpretation and rendering.

To help address these problems, systems, methods, apparatuses, and computer-readable media, or more generally, techniques, are provided herein to improve the compression picture quality of shared content in video conferencing while maintaining the flexibility to allow interaction in presentation. In some embodiments, a video conferencing application causes to generate for display, at a receiver device, shared content from a presenter device during a video conference, wherein the shared content comprises a first slide of a plurality of slides in a slide presentation. In some examples, the video conferencing application generates the shared content for display at the receiver device through a screen-sharing functionality. In some embodiments, the video conferencing application collects presentation data from the presenter device, causes encoding, at the presenter device, of the presentation data, transmits, to the receiver device, the encoded presentation data and stores, in a buffer at the receiver device, the encoded presentation data. In some examples, based at least in part on detecting a user interface input at the presenter device, the video conferencing application causes to decode the encoded presentation data stored in the buffer at the receiver device and causes to generate for display, at the receiver device, the decoded presentation data.

Such aspects use video compression to improve the picture quality of shared content when presentation material is not accessible beforehand, and video conferencing applications deliver content to remote participants using just-in-time encoding. The proposed asynchronous compression of presentation content is able to deliver a high-quality slide before the presentation progresses or skips to the slide and offers flexibility of synchronized presentation or non-synchronized audience browsing, ensuring an interactive presentation flow. Associated with the asynchronous encoding and delivery, content buffering and management allow a better experience in the case of presentation sharing and re-sharing.

In some embodiments, the presentation data is image data corresponding to a second slide of the plurality of slides in the slide presentation, and the user interface input at the presenter device is a user selection at the presenter device to navigate to the second slide of the plurality of slides in the slide presentation. In some implementations, the image data corresponding to a second slide of the plurality of slides in the slide presentation is a bitstream of multiple frames of the second slide, and the video conferencing application causes to encode, at the presenter device, the presentation data by transcoding, at the presenter device, the multiple frames of the second slide to a single high-quality frame of the second slide. In some examples, the video conferencing application replaces the bitstream of multiple frames of the second slide with the single high-quality frame of the second slide.

Such aspects provide the receiver devices with the capability to store an encoded version of a next or future slide much earlier than the slide's presentation. Video conferencing applications use such asynchronized encoding techniques to deliver the best quality of those slides beforehand and ensure that the receiving participant will have the best quality at the time of presenting each new slide. Further, the process of transcoding, at a presenter device, multiple frames of a slide to a single frame of high-quality slide for transmission to a receiver device will allow quick access and rendering of the high-quality version at the receiver device. This single frame decoding reduces the latency in video decoding, upon the receiver device's request for rendering and presentation.

In some embodiments, the video conferencing application detects that the presenter device has modified a second slide in the presentation. In such examples, the video conferencing application then collects image data corresponding to the modified second slide; causes to encode, at the presenter device, the data from the modified second slide; and transmits the encoded modified second slide data to the receiver device. In some examples, the video conferencing application then compares the encoded modified second slide data to the original second slide data to determine a measurement of the similarity of the modified second slide and the original second slide. In some embodiments, if the similarity measurement is below a certain threshold value, the video conferencing application stores the modified second slide data in the buffer at the receiver device. In some examples, if the video conferencing application detects a user selection at the presenter device to navigate to the modified second slide, the video conferencing application causes decoding of the modified second slide stored in the buffer at the receiver device, and generates for display, at the receiver device, the decoded modified second slide. In some embodiments, the video conferencing application replaces the presentation data in the buffer at the receiver device with the encoded modified second slide data.

In some embodiments, the video conferencing application detects that the presenter device has made modifications to multiple slides in the presentation. In such examples, the video conferencing application collects data for the modifications to the multiple slides, causes encoding, at the presenter device, of the data for the modifications to the multiple slides, and transmits the encoded data for the modifications to the multiple slides to the receiver device. In some implementations, the video conferencing application overlays the modifications to the multiple slides over the original slides that were stored in the buffer at the receiver device and stores the overlaid slides in the buffer at the receiver device. In some embodiments, the overlaid slides are new encodings of the modified slides that replace the encoded pictures of the unmodified slides. In some embodiments, when the video conferencing application detects that the presenter device is navigating to a next slide in the presentation, the video conferencing application causes decoding of the overlaid updated presentation data stored in the buffer at the receiver device, and causes to generate for display, at the receiver device, the decoded overlaid updated presentation data.

In some embodiments, when the video conferencing application detects that the presenter device has initiated additional actions, e.g., moving a mouse or highlighting text, the video conferencing application triggers resuming the real-time video compression of the slides along with the actions visible on the screen by causing to decode the presentation data encoded in the buffer at the receiver device, modifying the decoded presentation data based on the user interface input at the receiver device, and causing to generate for display, at the receiver device, the modified decoded presentation data.

Such aspects eliminate encoding an IDR or intra-frame, which introduces a spike in bitrate, for example. Each static slide is sent as a high-quality (or encoded at a high bitrate) I-frame beforehand, e.g., across a duration of multiple frames. When there is a change, the sender side sends only the interactive or modified content as motion vectors and residuals to the receiver side in P-frames, for example. Additional content, such as videos embedded in a slide, is also preloaded, encoded, and delivered to the receiver. The receiver side initiates an image fusion or composition method to overlay the modified or interactive content onto the high-quality version of the slide already available to the participant. After decoding the received modifications, the video conferencing application uses techniques such as masking for overlaying the additional visual elements, e.g., mouse movement, annotation, etc., onto the high-quality static background. The modified content may be encoded and delivered in lower quality due to a limited bandwidth of the uplink, compared to the preloaded high-quality background. If the sender side stopped sharing and resumes sharing the content with changes, the receiver may reload the preloaded content to incorporate those changes, for example. To optimize this, the receiver side maintains a buffer to store delivered and buffered slides for a specified duration (e.g., until the meeting ends). This buffer allows the receiver to avoid reloading the content during a resharing scenario. If the changes are minor, the receiver side receives only the updates and overlays those to the preloaded slides without reloading. If major changes are present, the buffer may be shuffled to accommodate new content.

In some implementations, the video conferencing application uses slices and tiles to independently encode and decode for flexible content delivery and rendering. In some embodiments, the video conferencing application applies sub-portions to slides for progressive quality improvement, particularly for interactions with a presentation. In some embodiments, the video conferencing application uses tiles, and portions of a document display/page are encoded and delivered as I-tiles only. In some examples, embedded videos or animations are encoded with I-, P- and B-tiles for that section of the presentation display only. In some embodiments, for static portions of presentations, only the I-tiles will be decoded and displayed covering the non-video portion of the page. In such examples, the video portion of the page will be I-tiles combined with P- and B-tiles for the encoded video.

In some embodiments, each slide of a presentation (or page of a document, etc.) may be encoded in a set of tiles, for example, 16×8 tiles per page. In such examples, the initial encodings will all be I-tiles. In some embodiments, tiles from one encoded page are combined with tiles from another encoded page to be retrieved, decoded and rendered at the proper location based on where the presenter device has scrolled to when multiple pages are shown in a display viewport. In some embodiments, this may also be adjusted based on zoom level. For example, if a page is zoomed out to display three pages, the tiled encodings may be retrieved and decoded with the decoded tiles rendered in the proper locations based on combining a zoom level and scroll location.

### BRIEF DESCRIPTION OF THE DRAWINGS

The present disclosure, in accordance with one or more various embodiments, is described with reference to the following figures. The drawings are provided for purposes of illustration only and merely depict typical or example embodiments. These drawings are provided to facilitate an understanding of the concepts disclosed herein and do not limit the breadth, scope, or applicability of these concepts. It should be noted that for clarity and ease of illustration these drawings are not necessarily made to scale.

FIGS. 1A and 1B are illustrative examples of a system for improving presentation sharing in video conferencing, in accordance with some embodiments of the present disclosure;

FIG. 2 is an illustrative example of encoding slides of a presentation and delivering bitstreams to remote participants, in accordance with some embodiments of the present disclosure;

FIG. 3 is an illustrative example of asynchronized encoding of slides partly decoupled from a presentation, in accordance with some embodiments of the present disclosure;

FIG. 4 is an illustrative example of transcoding frames of a slide to a single high-quality frame for fast access and decoding, in accordance with some embodiments of the present disclosure;

FIG. 5 is a sequence diagram for improving presentation sharing in video conferencing when slides are updated and reshared by the presenter device during the presentation, in accordance with some embodiments of the present disclosure;

FIG. 6 is a flowchart of an illustrative process for improving presentation sharing in video conferencing, in accordance with some embodiments of the present disclosure;

FIG. 7 is a sequence diagram for improving presentation sharing in video conferencing, in accordance with some embodiments of the present disclosure;

FIG. 8 is a diagram of an illustrative media device, in accordance with some embodiments of the present disclosure;

FIG. 9 is a diagram of an illustrative system for improving presentation sharing in video conferencing, in accordance with some embodiments of the present disclosure;

FIG. 10 is a flowchart of an illustrative process for improving presentation sharing in video conferencing when slides are modified by the presenter during presentation, in accordance with some embodiments of the present disclosure; and

FIG. 11 is a flowchart of an illustrative process for improving presentation sharing in video conferencing when the receiver is modifying the presentation, in accordance with some embodiments of the present disclosure.

### DETAILED DESCRIPTION

To improve video conferencing, new methods and systems are provided to improve the picture quality of shared content, such as slides in a presentation. When someone deploying these systems and methods shares their screen during a video conference, images of the presentation are clearer and sharper. The methods and systems work, for example, by sending the presentation data in an improved way that can deliver high quality images, even if the slides are not shared beforehand. This helps everyone see the slides clearly and interact with the presentation smoothly. In doing so, the presentation content is easily shared and re-shared. Additionally, the system prepares the next slide in advance, so the next slide is ready to show in high quality, which reduces the waiting time for the slides to appear clearly. If the presenter makes changes to the slides, the methods and systems update the slides to ensure that everyone sees the latest version. In so doing, the presentation remains smooth and interactive, even if there are changes or updates during the call. The methods and systems also detect actions like moving a mouse or highlighting text and updates the slides in real-time to show these interactions. The methods and systems send only the changes, not the whole slide again, which saves time and keeps the picture quality high. Videos embedded in slides are also preloaded and shown in high quality. If the presenter stops and then resumes sharing, the methods and systems quickly reload the slides without starting from scratch, which makes the whole experience faster and smoother for everyone. Further, the methods and systems use techniques to improve the picture quality of different parts of the slides, like videos or animations, ensuring that everything looks great and works well during the presentation. Each slide may be broken down into smaller parts, e.g., tiles, which are combined and adjusted based on zoom level and scroll position to display the content correctly, which helps keep everything clear and in the right place, no matter how the presenter moves through the slides.

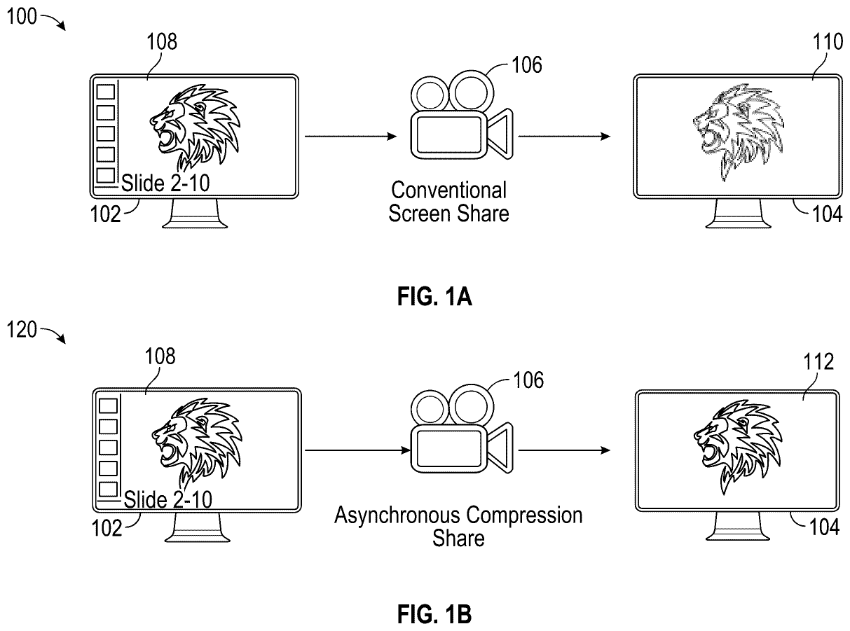

Turning to some representative embodiments, FIG. 1A is an illustrative example of a system for improving presentation sharing in video conferencing, in accordance with some embodiments of the present disclosure. In some embodiments, system 100 includes presenter device 102, receiver device 104, and video conferencing application 106. In some embodiments, presenter device 102 and receiver device 104 may be laptop computers, smartphones, smart monitors, or any other computing devices. In some implementations, video conferencing application 106 is web-based live video conferencing implemented in software on presenter device 102 and receiver device 104. System 100 may comprise any suitable number of computing devices, servers, databases, communication networks, or any other suitable components, or any suitable combination thereof. System 100 may be configured to perform the functionalities (or one or more portions thereof) described herein. In some embodiments, system 100 may comprise or be incorporated as part of any suitable application or software.

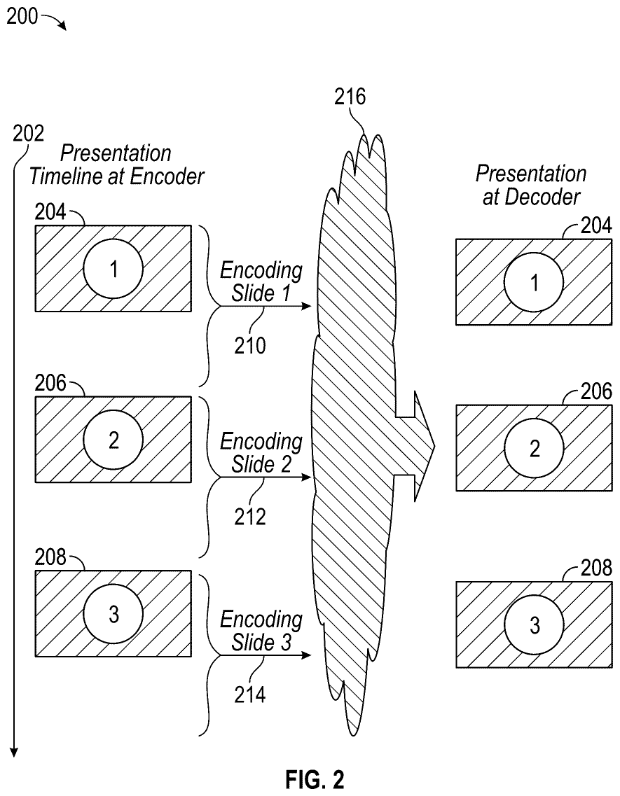

In some embodiments, presenter device 102 is presenting content 108. In some examples, content 108 is a slide of a slide presentation. In some examples, content 108 is a page of a word document, PDF, spreadsheet, or Visio file. In some examples, content 108 is a part of an image file, audio file, video file, or web development file, or any other type of file that can be shared through a video conferencing application. In some embodiments, presenter device 102 is sharing content 108, through video conferencing application 106, to receiver device 104 using a conventional screen share, as described further below with reference to FIG. 2. In some embodiments, content 108 is presented as low-quality content 110 at receiver device 104, because, for example, when shared content is subject to video compression and then gets delivered to remote participants, the picture quality of the shared content depends on the uplink bandwidth of presenter device 102 as well as the downlink bandwidth of receiver device 104. In some examples, video compression at a low bitrate has degraded the quality of content 108 so that content 108 appears as low-quality content 110, with reduced resolution, clarity, and definition compared to the appearance of content 108 on presenter device 102.

FIG. 1B is an illustrative example of a system for improving presentation sharing in video conferencing, in accordance with some embodiments of the present disclosure. In some embodiments, system 120 includes presenter device 102, receiver device 104, and video conferencing application 106. In some embodiments, presenter device 102 and receiver device 104 may be laptop computers, smartphones, smart monitors, or any other computing devices. In some implementations, video conferencing application 106 is web-based live video conferencing implemented in software on presenter device 102 and receiver device 104. System 120 may comprise any suitable number of computing devices, servers, databases, communication networks, or any other suitable components, or any suitable combination thereof. System 120 may be configured to perform the functionalities (or one or more portions thereof) described herein. In some embodiments, system 120 may comprise or be incorporated as part of any suitable application or software.

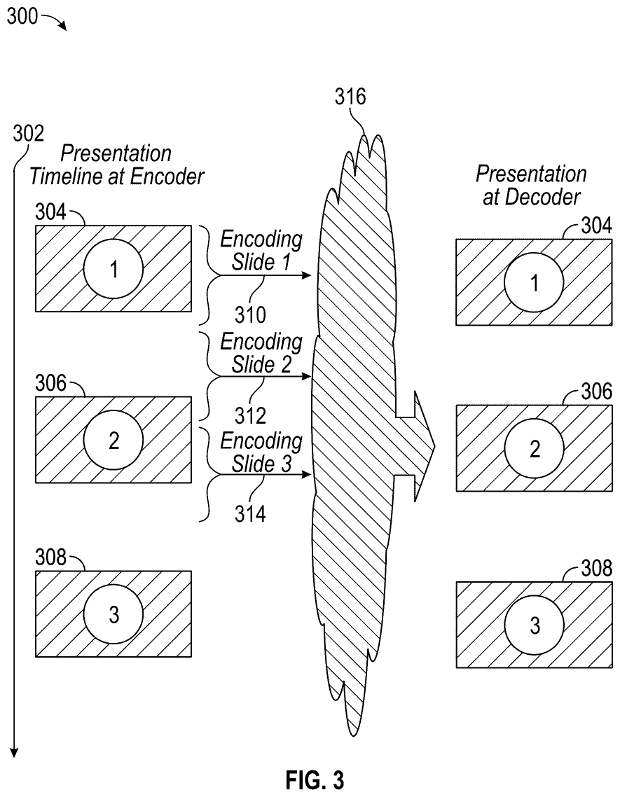

In some embodiments, presenter device 102 is presenting content 108. In some examples, content 108 is a slide of a slide presentation. In some examples, content 108 is a page of a word document, PDF, spreadsheet, or Visio file. In some examples, content 108 is a part of an or image file, audio file, video file, or web development file, or any other type of file that can be shared through a video conferencing application. In some embodiments, presenter device 102 is sharing content 108, through video conferencing application 106, to receiver device 104 using asynchronous compression techniques, as described further below with reference to FIGS. 3, 4, 6, and 7. In some embodiments, content 108 is presented as high-quality content 112 (identical quality to content 108) at receiver device 104, because, for example, video compression of content 108 is optimized to deliver the best picture quality within a limited time duration, as described further below with reference to FIG. 3.

FIG. 2 is an illustrative example of encoding slides of a presentation and delivering bitstreams to remote participants, in accordance with some embodiments of the present disclosure. In some embodiments, system 200 includes first presentation slide 204, second presentation slide 206, and third presentation slide 208.

In some embodiments, first presentation slide 204, second presentation slide 206, and third presentation slide 208 are encoded (at 216) and delivered in a synchronized manner, along with presentation timeline 202. In some embodiments, a receiver device (e.g., receiver device 104 of FIG. 1A) receives the bitstream, which is decoded and presented (assuming an acceptable systematic end-to-end latency) along nearly the same timeline of the presenter device (e.g., presenter device 102 of FIG. 1A). For example, at 210, a video conferencing application (e.g., video conferencing application 106 of FIG. 1A) encodes first presentation slide 204 at a presenter device (e.g., presenter device 102 of FIG. 1A) while presenting first presentation slide 204 to a receiver device (e.g., receiver device 104 of FIG. 1A); at 212, the video conferencing application encodes second presentation slide 206 at the presenter device while decoding second presentation slide 206 at the receiver device; and at 214, the video conferencing application encodes third presentation slide 208 at the presenter device while decoding third presentation slide 208 at the receiver device.

FIG. 3 is an illustrative example of asynchronized encoding of slides partly decoupled from a presentation, in accordance with some embodiments of the present disclosure. In some embodiments, system 300 includes first presentation slide 304, second presentation slide 306, and third presentation slide 308.

In some embodiments, first presentation slide 304, second presentation slide 306, and third presentation slide 308 are encoded (see 316) and delivered in an asynchronized manner, which does not follow or tightly couple with presentation timeline 302 in all circumstances. In some examples, the content in the slides is limited, and typically includes static textual and graphical presentations. In some embodiments, the video compression of such slides is optimized to deliver the best picture quality within a much shorter time duration than the presentation time duration. For example, at 310, a video conferencing application (e.g., video conferencing application 106 of FIG. 1B) encodes first presentation slide 304 at a presenter device (e.g., presenter device 102 of FIG. 1B) while decoding first presentation slide 304 at a receiver device (e.g., receiver device 104 of FIG. 1B); at 312, the video conferencing application encodes second presentation slide 306 at the presenter device prior to presenting second presentation slide 306 to the receiver device; and at 314, the video conferencing application encodes third presentation slide 308 at the presenter device while the first or second presentation slide 306 is still decoding at the receiver device.

In some embodiments, the video conferencing encodes a next or future slide much earlier than the slide's presentation to deliver the best quality of slides to the receiver device in time for presentation of each new slide. In some embodiments, while the encoding is asynchronized with the presentation at the encoder, the presentation at the decoder is easily synchronized with the presentation, for example, with different ways of signaling, e.g., through low bandwidth and low latency communication within a video conferencing system. In some embodiments, the encoding and delivery of high-quality content for the next slides do not have to follow the order of slides as those appear at the presenter side. For example, non-linear encoding in the proposed asynchronized delivery of slides considers how many remote participants select a future slide in the remote participants' audience view. In some examples, such optimization may also be constrained if a system allows an audience view of only the slides that the presenter has already presented and shared.

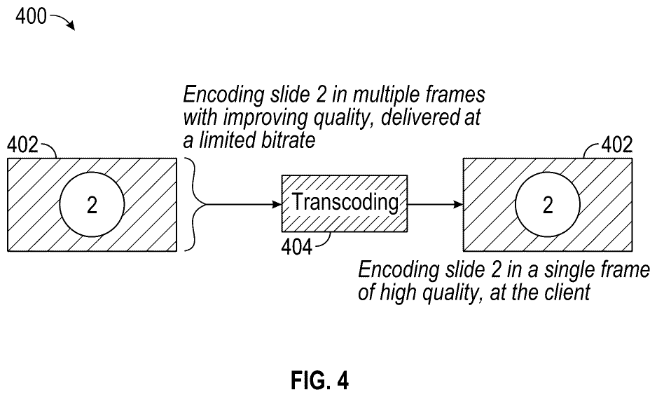

FIG. 4 is an illustrative example of transcoding frames of a slide to a single high-quality frame for fast access and decoding at a later time, in accordance with some embodiments of the present disclosure. In some embodiments, system 400 includes second presentation slide 402 and transcoding circuitry 404. In some embodiments, transcoding circuitry 404 is part of a presenter device (e.g., presenter device 102 of FIG. 1B) that is sharing a slide presentation including second presentation slide 402. In some embodiments, transcoding circuitry 404 transcodes multiple lower-quality frames of second presentation slide 402 to a single high-quality frame to allow quick access and rendering of the high-quality version at a receiver device (e.g., receiver device 104 of FIG. 1B) receiving the shared slide presentation. In some embodiments, the single frame decoding reduces latency upon the receiver device's request for rendering and presentation. In some embodiments, once the high-quality encoded version is available, the bitstream of multiple frames is replaced, i.e., no longer stored as a duplicate in the presenter device.

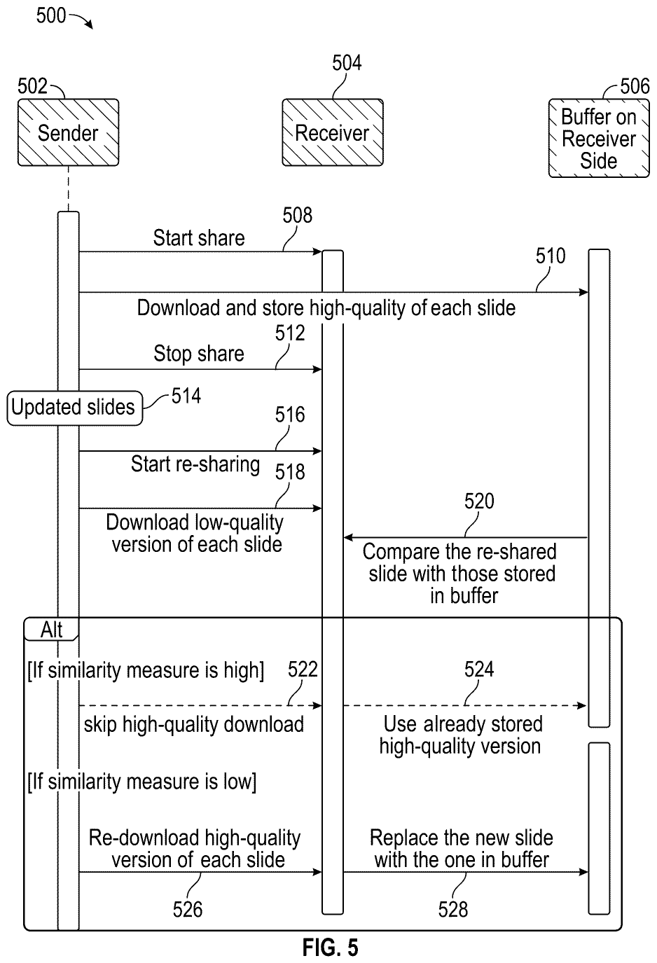

FIG. 5 is a sequence diagram for improving presentation sharing in video conferencing when slides are updated and reshared by the presenter device during the presentation, in accordance with some embodiments of the present disclosure. In some embodiments, process 500 includes sender device 502 (e.g., presenter device 102 of FIG. 1B), receiver device 504 (e.g., receiver device 104 of FIG. 1B) and buffer on the receiver side 506. The actions or descriptions of FIG. 5 may be used with any other embodiment of this disclosure. In addition, the actions and descriptions described in relation to FIG. 5 may be done in suitable alternative orders or in parallel to further the purposes of this disclosure.

In some embodiments, at 508, sender 502 starts sharing presentation content with receiver 504, e.g., through a screen-sharing functionality of a video conferencing application hosting a video conference between sender 502 and receiver 504. At 510, the client on receiver side 506 downloads and stores in buffer each slide received from sender 502 in a high-quality format. At 512, sender 502 stops sharing presentation content with receiver 504. At 514, sender 502 updates the slides in the presentation. For example, sender 502 receives a user selection to modify a second slide of the slides in the presentation. At 516, sender 502 starts re-sharing the updated slides with receiver 504. For example, receiver 504 collects the data with the modification to the second slide of the slides in the presentation, encodes the data of the modification to the second slide, and then transmits the encoded data of the modification to the second slide to receiver 504. At 518, receiver 504 downloads low-quality versions of each slide received from sender 502. At 520, the client on receiver side 506 compares the re-shared updated slides at receiver 504 with the slides already stored in the buffer on the receiver side 506 to determine a similarity measurement.

In some embodiments, at 520, if the similarity measure between the re-shared updated slides at receiver 504 with the slides already stored in the buffer on the receiver side 506 is high, e.g., above a threshold value preset in the settings for the receiver 504, process 500 proceeds to 522. In some embodiments, at 520, if the similarity measure between the re-shared updated slides at receiver 504 with the slides already stored in the buffer on the receiver side 506 is low (because, for example, substantial changes have been made), e.g., below a threshold value preset in the settings for the receiver 504, process 500 proceeds to 526.

At 522, receiver 504 skips doing a download of a high-quality version of the updated slides received from sender 502. At 524, receiver 504 uses the high-quality version of the original slides already stored in the buffer on the receiver side 506 when generating the presentation for display, e.g., upon receiving a user selection at sender 502 to navigate to the modified second slide.

At 526, receiver 504 re-downloads a high-quality version of the updated slides received from sender 502. At 528, receiver 504 replaces the already stored high-quality version of the original slides with the new high-quality version of the updated slides in the buffer on the receiver side 506 and then uses the new high-quality version of the updated slides when generating the presentation for display, e.g., upon receiving a user selection at sender 502 to navigate to the modified second slide.

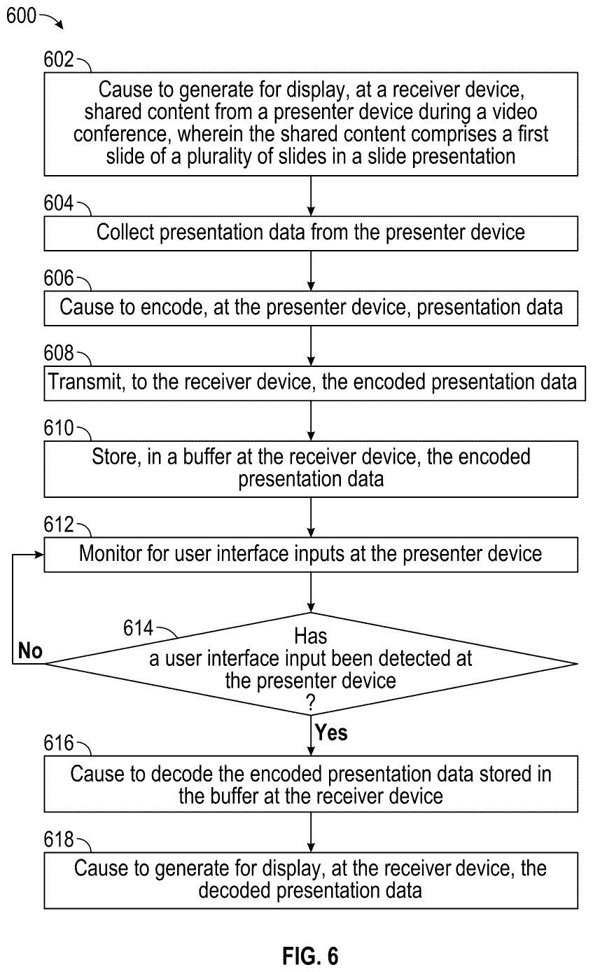

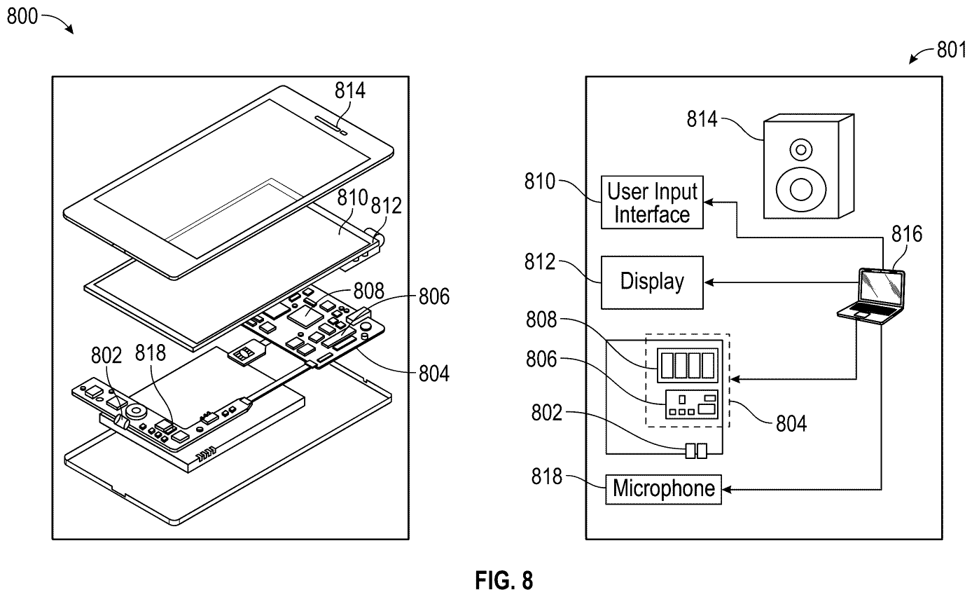

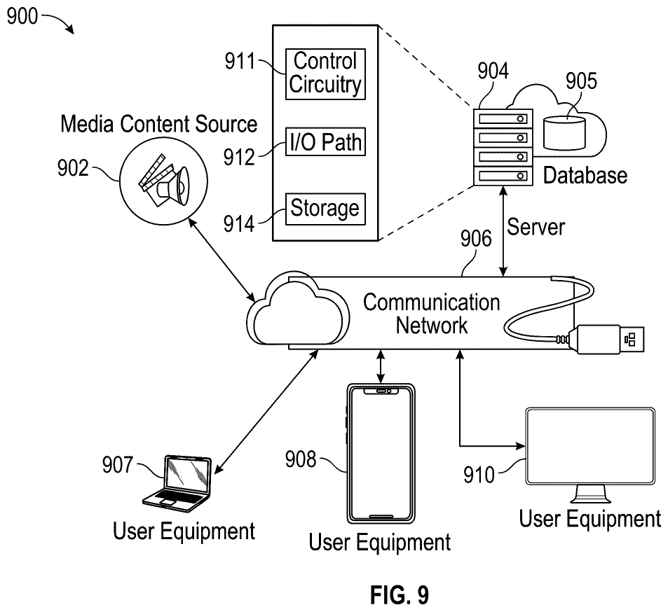

FIG. 6 is a flowchart of an illustrative process for improving presentation sharing in video conferencing, in accordance with some embodiments of the present disclosure. In various embodiments, the individual steps of process 600 may be implemented by system 120 of FIG. 1B, for example, by the video conferencing application, or by using the control circuitry of presenter device 102 or receiver device 104. For example, non-transitory memories of one or more components of presenter device 102 or receiver device 104 or devices of FIGS. 8 and 9, e.g., storage 914 and control circuitry 911, may store instructions that, when executed by the control circuitry of presenter device 102 or receiver device 104 or devices of FIGS. 8 and 9 (as described further below with reference to FIGS. 8 and 9), cause execution of the process depicted in FIG. 6. The actions or descriptions of FIG. 6 may be used with any other embodiment of this disclosure. In addition, the actions and descriptions described in relation to FIG. 6 may be done in suitable alternative orders or in parallel to further the purposes of this disclosure.

In some embodiments, at 602, the video conferencing application causes generation for display, at a receiver device (e.g., receiver device 104 of FIG. 1B), shared content from a presenter device (e.g., presenter device 102 of FIG. 1A) during a video conference. In some embodiments, the shared content comprises a first slide of a plurality of slides in a slide presentation. In some examples, the shared content is generated for display at the receiver device through a screen-sharing functionality of a video conferencing application hosting the video conference. At 604, the video conferencing application collects presentation data from the presenter device. In some embodiments, the presentation data is image data corresponding to a second slide of the plurality of slides in the slide presentation. In some implementations, the presentation data is a bitstream of multiple frames of the second slide. In some embodiments, the video conferencing application collects the presentation data from the presenter device by detecting a shared window corresponding to the slide presentation at the presenter device, and collecting image data corresponding to the plurality of slides in the slide presentation by capturing an image of each slide of the plurality of slides in the slide presentation. In some examples, there is more than one shared window in the desktop space of the presenter device, so the video conferencing application detects the shared window that is corresponding to an application that the presenter device is using to present content. In some implementations, the video conferencing application, while causing generation for display, at the receiver device, of the first slide of the plurality of slides, captures an image of a second slide of the plurality of slides, and captures an image of a third slide of the plurality of slides.

At 606, the video conferencing application causes to encode, at the presenter device, the presentation data. In some embodiments, the video conferencing application transcodes, at the receiver device, multiple frames of the second slide to a single high-quality frame of the second slide, as described further above with reference to FIG. 4. In some embodiments, the video conferencing application replaces the bitstream of multiple frames of the second slide with the single high-quality frame of the second slide, as described further above with reference to FIG. 4. In some embodiments, the presentation data is image data corresponding to the plurality of slides in the slide presentation, e.g., a captured image of every slide in the slide presentation.

In some embodiments, the video conferencing application causes to encode, at the presenter device, the presentation data by optimizing video compression, at the presenter device, including determining picture types for each image included in the image data corresponding to the plurality of slides in the slide presentation. In some embodiments, the video conferencing application causes to encode, at the presenter device, the presentation data by periodically causing insertion of instantaneous decoder refresh (IDR) frames for each slide of the plurality of slides in the slide presentation. In some examples, the video conferencing application causes to encode, at the presenter device, the presentation data by causing encoding an intra-coded (I) frame or IDR frame for each slide of the plurality of slides in the slide presentation; and causing encoding predicted (P) frames and bidirectional (B) frames to signal changes made to the slide presentation at the presenter device. In some implementations, each P or B frame references other frames in the stream and is signaling changes relative to those referenced frames.

In some embodiments, the video conferencing application causes to encode, at the presenter device, the presentation data by causing to compare, at the presenter device, the first slide and a second slide of the plurality of slides to determine a similarity measurement. In some examples, based at least in part on determining, at the presenter device, that the similarity measurement is below a threshold value, the video conferencing application causes insertion of an I frame or an IDR frame at encoding the second slide of the plurality of slides. In some examples, based at least in part on determining, at the presenter device, that the similarity measurement is above a threshold value, the video conferencing application causes encoding of the second slide as a P frame or a B frame. In some embodiments, the video conferencing application causes to encode, at the presenter device, the presentation data by causing encoding a second slide of the plurality of slides to an IDR frame at a high bitrate and causing delivery of the IDR frame in a duration of multiple frames. In some embodiments, the video conferencing application causes to encode, at the presenter device, the presentation data by determining the number of slides of the plurality of slides and causing encoding a number of frames corresponding to the number of slides for transmission. For example, the video conferencing application determines that the frame rate of transmission is 30 frames per second, so it encodes 60 frames to be transmitted in 2 seconds. In some embodiments, the video conferencing application causes to encode, at the presenter device, the presentation data by using, at the presenter device, encoding settings optimized for a target bitrate.

At 608, the video conferencing application transmits, to the receiver device, the encoded presentation data. In some embodiments, the video conferencing application transmits the encoded presentation data through a server and then to the receiver device. In some embodiments, the video conferencing application transmits, to the receiver device, the encoded presentation data by transmitting image analysis information of the second slide to the receiver device. At 610, the video conferencing application stores, in a buffer at the receiver device, the encoded presentation data. At 612, the video conferencing application monitors for user interface inputs at the presenter device. At 614, the video conferencing application determines whether a user interface input has been detected at the presenter device. In some embodiments, at 614, if the video conferencing application does not detect a user interface input, process 600 returns to 612. In some embodiments, at 614, if the video conferencing application does detect a user interface input, process 600 proceeds to 616. In some embodiments, the user interface input at the presenter device is a user selection at the presenter device to navigate to the second slide of the plurality of slides in the slide presentation. At 616, the video conferencing application causes to decode, at the receiver device, the encoded presentation data stored in the buffer. In some embodiments, the video conferencing application causes to decode, at the receiver device, the encoded presentation data stored in the buffer by causing retrieving of the I frame or IDR frame for the first slide from the buffer at the receiver device. At 618, the video conferencing application causes to generate for display, at the receiver device, the decoded presentation data, e.g., the second slide of the plurality of slides in the slide presentation.

In some embodiments, the video conferencing application then returns to 602 and carries out the steps of process 600 for a subsequent slide in the slide presentation. For example, the video conferencing application causes to generate for display, at the receiver device, the second slide of the plurality of slides in the slide presentation, collects image data corresponding to a third slide of the plurality of slides in the slide presentation from the presenter device, and causes to encode, at the presenter device, the image data of the third slide. In some examples, the video conferencing application then transmits, to the receiver device, the encoded image data from the third slide, and stores, in a buffer at the receiver device, the encoded image data from the third slide. In some embodiments, based at least in part on detecting a user selection at the presenter device to navigate to the third slide, the video conferencing application then causes to decode the encoded image data from the third slide stored in the buffer at the receiver device; and causes to generate for display, at the receiver device, the decoded image data from the third slide.

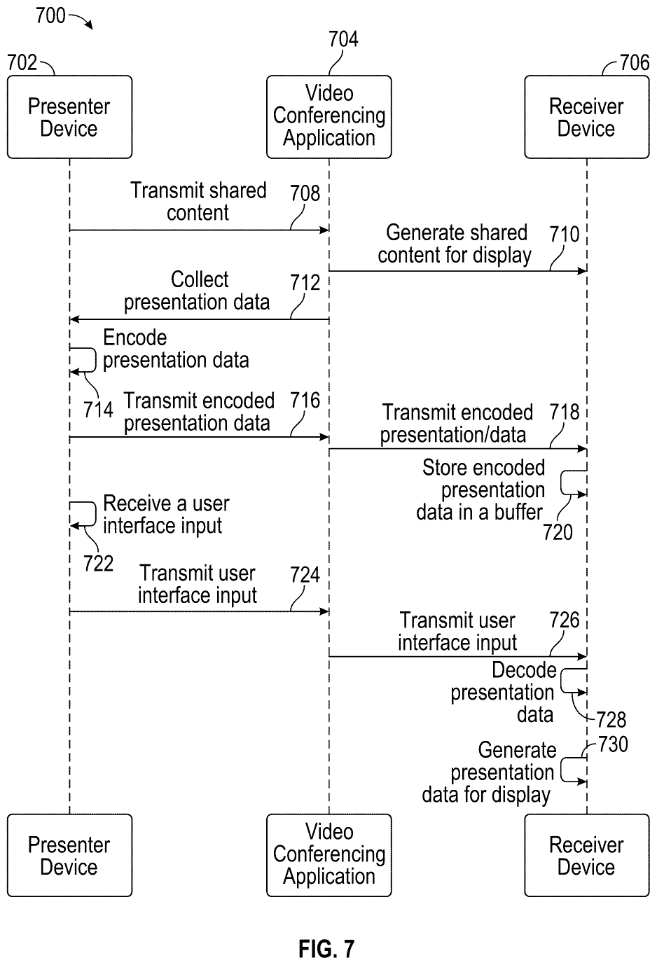

FIG. 7 is a sequence diagram for improving presentation sharing in video conferencing, in accordance with some embodiments of the present disclosure. In some embodiments, system 700 includes presenter device 702, video conferencing application 704, and receiver device 706. The actions or descriptions of FIG. 7 may be used with any other embodiment of this disclosure. In addition, the actions and descriptions described in relation to FIG. 7 may be done in suitable alternative orders or in parallel to further the purposes of this disclosure.

In some embodiments, at 708, presenter device 702 (e.g., presenter device 102 of FIG. 1B) transmits shared content to video conferencing application 704 (e.g., video conferencing application 106 of FIG. 1B). At 710, video conferencing application 704 generates shared content for display at receiver device 706 (e.g., receiver device 104 of FIG. 1B). At 712, video conferencing application 704 collects presentation data, e.g., image data corresponding to a second slide of the plurality of slides in the slide presentation, from presenter device 702. At 714, presenter device 702 encodes the presentation data. At 716, presenter device 702 transmits the encoded presentation data to video conferencing application 704. At 718, video conferencing application 704 transmits the encoded presentation data to receiver device 706. At 720, the receiver device 706 stores the encoded presentation data in a buffer. At 722, presenter device 702 receives a user interface input. At 724, presenter device 702 transmits the user interface input to video conferencing application 704. At 726, video conferencing application 704 transmits the user interface input to receiver device 706. At 728, receiver device 706 decodes the presentation data. At 730, receiver device 706 generates the presentation data for display at receiver device 706.

FIGS. 8 and 9 describe exemplary devices, systems, servers, and related hardware for improving presentation sharing in video conferencing, in accordance with some embodiments of the present disclosure. FIG. 8 shows generalized embodiments of illustrative devices 800 and 801. For example, devices 800 and 801 may be smartphone devices, laptop computers, smart monitors, televisions, or any other computing devices. Device 801 may include computer 816. Computer 816 may be communicatively connected to microphone 818, speakers 814, and display 812. In some embodiments, microphone 818 may receive voice commands. In some embodiments, display 812 may be an external display connected to computer 816. In some embodiments, computer 816 may be communicatively connected to user input interface 810. In some embodiments, user input interface 810 may be a remote-control device. Computer 816 may include one or more circuit boards. In some embodiments, the circuit boards may include processing circuitry, control circuitry, and storage (e.g., RAM, ROM, Hard Disk, Removable Disk, etc.). In some embodiments, the circuit boards may include an input/output path. More specific implementations of devices are discussed below in connection with FIG. 8. Each one of devices 800 and 801 may receive data via input/output (“I/O”) path 802. I/O path 802 may provide data to control circuitry 804, which includes processing circuitry 806 and storage 608. Control circuitry 804 may be used to send and receive commands, requests, and other suitable data using I/O path 802, which may comprise I/O circuitry. I/O path 802 may connect control circuitry 804 (and specifically processing circuitry 606) to one or more communications paths (described below). I/O functions may be provided by one or more of these communications paths but are shown as a single path in FIG. 8 to avoid overcomplicating the drawing.

Control circuitry 804 may be based on any suitable processing circuitry such as processing circuitry 806. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 804 executes instructions for a video conferencing application stored in memory (i.e., storage 808). Specifically, control circuitry 804 may be instructed by the video conferencing application to perform the functions discussed above and below. In some implementations, any action performed by control circuitry 804 may be based on instructions received from the video conferencing application.

In client/server-based embodiments, control circuitry 804 may include communications circuitry suitable for communicating with networks or servers. The instructions for carrying out the above-mentioned functionality may be stored on a server (which is described in more detail in connection with FIG. 8). Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the internet or any other suitable communication networks or paths (which is described in more detail in connection with FIG. 8). In addition, communications circuitry may include circuitry that enables peer-to-peer communication of devices, or communication of devices in locations remote from each other (described in more detail below).

Memory may be an electronic storage device provided as storage 808 that is part of control circuitry 804. As referred to herein, the phrase “electronic storage device” or “storage device” should be understood to mean any device for storing electronic data, computer software, or firmware, such as random-access memory, read-only memory, hard drives, optical drives, recorders, solid state devices, quantum storage devices, or any other suitable fixed or removable storage devices, and/or any combination of the same. Storage 808 may be used to store various types of content described herein as well as data described above. Nonvolatile memory may also be used (e.g., to launch a boot-up routine and other instructions). Cloud-based storage, described in relation to FIG. 8, may be used to supplement storage 808 or instead of storage 808.

Control circuitry 804 may also include scaler circuitry for upconverting and downconverting content into the preferred output format of device 800. Circuitry 804 may also include digital-to-analog converter circuitry and analog-to-digital converter circuitry for converting between digital and analog signals. The circuitry described herein may be implemented using software running on one or more general purpose or specialized processors.

A user may send instructions to control circuitry 804 using user input interface 810. User input interface 810 may be any suitable user interface, such as a remote control, mouse, trackball, keypad, keyboard, touch screen, touchpad, stylus input, joystick, voice recognition interface, or other user input interfaces. In some embodiments, user input interface 810 is composed of capacitive touch technology, resistive touch technology, or proximity sensors. Display 812 may be provided as a stand-alone device or integrated with other elements of each one of device 800 and device 801. For example, display 812 may be a touchscreen or touch-sensitive display. In such circumstances, user input interface 810 may be integrated with or combined with display 812. Display 812 may be one or more of a monitor, a television, a display for a mobile device, or any other type of display. A video card or graphics card may generate the output to display 812. The video card may be any processing circuitry described above in relation to control circuitry 804. The video card may be integrated with the control circuitry 804. Speakers 814 may be provided as integrated with other elements of each one of device 800 and device 801 or may be stand-alone units. The audio component of videos and other content displayed on display 812 may be played through the speakers 814. In some embodiments, the audio may be distributed to a receiver (not shown), which processes and outputs the audio via speakers 814.

The video conferencing application may be implemented using any suitable architecture. For example, the video conferencing application may be a stand-alone application wholly implemented on each one of device 800 and device 801. In such an approach, instructions of the video conferencing application are stored locally (e.g., in storage 808), and data for use by the video conferencing application is downloaded on a periodic basis (e.g., from an out-of-band feed, from an internet resource, or using another suitable approach). Control circuitry 804 may retrieve instructions of the video conferencing application from storage 808 and process the instructions. Based on the processed instructions, control circuitry 804 may determine what action to perform when input is received from user input interface 810. For example, movement of a cursor on a display up/down may be indicated by the processed instructions when user input interface 810 indicates that an up/down button was selected.

In some embodiments, the video conferencing application is a client/server-based application. Data for use by a thick or thin client implemented on each one of device 800 and device 801 is retrieved on-demand by issuing requests to a server remote to each one of device 800 and device 801. In one example of a client/server-based guidance application, control circuitry 804 runs a web browser that interprets web pages provided by a remote server. For example, the remote server may store the instructions for the video conferencing application in a storage device. The remote server may process the stored instructions using circuitry (e.g., control circuitry 804) to perform the operations discussed in connection with FIGS. 1-7.

In some embodiments, the video conferencing application may be downloaded and interpreted or otherwise run by an interpreter or virtual machine (run by control circuitry 804). In some embodiments, the video conferencing application may be encoded in the ETV Binary Interchange Format (EBIF), received by the control circuitry 804 as part of a suitable feed, and interpreted by a user agent running on control circuitry 804. For example, the video conferencing application may be an EBIF application. In some embodiments, the video conferencing application may be defined by a series of JAVA-based files that are received and run by a local virtual machine or other suitable middleware executed by control circuitry 804. In some of such embodiments (e.g., those employing MPEG-2 or other digital media encoding schemes), the video conferencing application may be, for example, encoded and transmitted in an MPEG-2 object carousel with the MPEG audio and video packets of a program.

FIG. 9 is a diagram of an illustrative system for improving presentation sharing in video conferencing, in accordance with some embodiments of the disclosure. Devices 907, 908, 910 (e.g., presenter device 102 and receiver device 104 of FIG. 1B, which may be laptop computers, smartphones, smart monitors, or any other computing devices) may be coupled to communication network 906. Communication network 906 may be one or more networks including the internet, a mobile phone network, mobile voice, or data network (e.g., a 4G or LTE network), cable network, public switched telephone network, or other types of communication network or combinations of communication networks. Paths (e.g., depicted as arrows connecting the respective devices to the communication network 906) may separately or together include one or more communications paths, such as a satellite path, a fiber-optic path, a cable path, a path that supports internet communications (e.g., IPTV), free-space connections (e.g., for broadcast or other wireless signals), or any other suitable wired or wireless communications path or combination of such paths. Communications with the client devices may be provided by one or more of these communications paths but are shown as a single path in FIG. 9 to avoid overcomplicating the drawing.

Although communications paths are not drawn between devices, these devices may communicate directly with each other via communications paths as well as other short-range, point-to-point communications paths, such as USB cables, IEEE 1394 cables, wireless paths (e.g., Bluetooth, infrared, IEEE 702-11x, etc.), or other short-range communication via wired or wireless paths. The devices may also communicate with each other directly through an indirect path via communication network 906.

System 900 includes a media content source 902 and a server 904, which may comprise or be associated with database 905. Communications with media content source 902 and server 904 may be exchanged over one or more communications paths but are shown as a single path in FIG. 9 to avoid overcomplicating the drawing. In addition, there may be more than one of each of media content source 902 and server 904, but only one of each is shown in FIG. 9 to avoid overcomplicating the drawing. If desired, media content source 902 and server 904 may be integrated as one source device.

In some examples, the processes outlined within system 900 are performed by one of devices 907-910. In some embodiments, server 904 may include control circuitry 911 and a storage 914 (e.g., RAM, ROM, Hard Disk, Removable Disk, etc.). In some embodiments, storage 914 may store instructions that when, executed by control circuitry 911, may cause control circuitry 911 to execute the steps outlined within system 900. Server 904 may also include an input/output path 912. I/O path 912 may provide device information, or other data, over a local area network (LAN) or wide area network (WAN), and/or other content and data to the control circuitry 911, which includes processing circuitry, and storage 914. The control circuitry 911 may be used to send and receive commands, requests, and other suitable data using I/O path 912, which may comprise I/O circuitry. I/O path 912 may connect control circuitry 911 (and specifically processing circuitry) to one or more communications paths.

Control circuitry 911 may be based on any suitable processing circuitry such as one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry 911 may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, the control circuitry 911 executes instructions for an emulation system application stored in memory (e.g., the storage 914). Memory may be an electronic storage device provided as storage 914 that is part of control circuitry 911.

Server 904 may retrieve guidance data from media content source 902, process the data as will be described in detail below, and forward the data to devices 907 and 910. Media content source 902 may include one or more types of content distribution equipment including a television distribution facility, cable system headend, satellite distribution facility, programming sources (e.g., television broadcasters, such as NBC, ABC, HBO, etc.), intermediate distribution facilities and/or servers, internet providers, on-demand media servers, and other content providers. NBC is a trademark owned by the National Broadcasting Company, Inc., ABC is a trademark owned by the American Broadcasting Company, Inc., and HBO is a trademark owned by the Home Box Office, Inc. Media content source 902 may be the originator of content (e.g., a television broadcaster, a Webcast provider, etc.) or may not be the originator of content (e.g., an on-demand content provider, an internet provider of content of broadcast programs for downloading, etc.). Media content source 902 may include cable sources, satellite providers, on-demand providers, internet providers, over-the-top content providers, or other providers of content. Media content source 902 may also include a remote media server used to store different types of content (including video content selected by a user), in a location remote from any of the client devices. Media content source 902 may also provide metadata that is used to identify segments of media content as described above. Any one of devices 907-910 may also be the originator of data (e.g., recorded conversations).

Client devices may operate in a cloud computing environment to access cloud services. In a cloud computing environment, various types of computing services for content sharing, storage or distribution are provided by a collection of network-accessible computing and storage resources, referred to as “the cloud.” For example, the cloud can include a collection of server computing devices (such as, e.g., server 904), which may be located centrally or at distributed locations, which provide cloud-based services to various types of users and devices connected via a network such as the internet via communication network 906. In such embodiments, devices may operate in a peer-to-peer manner without communicating with a central server.

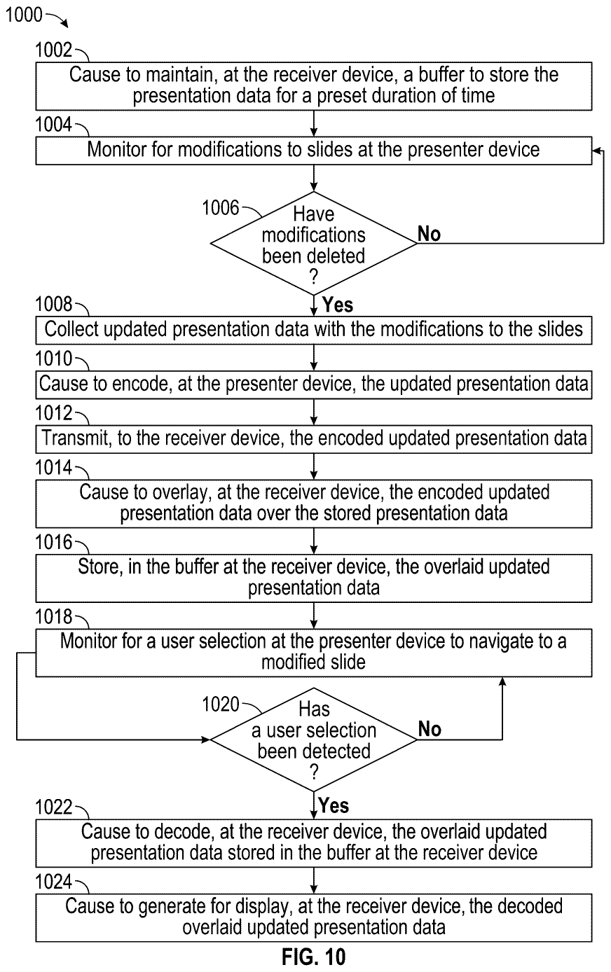

FIG. 10 is a flowchart of an illustrative process for improving presentation sharing in video conferencing when slides are modified by the presenter during presentation, in accordance with some embodiments of the present disclosure. In various embodiments, the individual steps of process 1000 may be implemented by system 120 of FIG. 1B, for example, by the video conferencing application, or by using the control circuitry of presenter device 102 or receiver device 104. For example, non-transitory memories of one or more components of presenter device 102 or receiver device 104 or devices of FIGS. 8 and 9, e.g., storage 914 and control circuitry 911, may store instructions that, when executed by the control circuitry of presenter device 102 or receiver device 104 or devices of FIGS. 8 and 9 (as described further above with reference to FIGS. 8 and 9), cause execution of the process depicted in FIG. 10. The actions or descriptions of FIG. 10 may be used with any other embodiment of this disclosure. In addition, the actions and descriptions described in relation to FIG. 10 may be done in suitable alternative orders or in parallel to further the purposes of this disclosure.

In some embodiments, at 1002, the video conferencing application causes the receiver device (e.g., receiver device 104 of FIG. 1B) to maintain a buffer to store the presentation data for a preset duration of time. At 1004, the video conferencing application monitors for modifications to slides at the presenter device (e.g., presenter device 102 of FIG. 1B), e.g., user selections to delete a few words from the slide or add a new photo. In some embodiments, if modifications have not been detected at 1006, process 1000 returns to 1004. In some embodiments, if modifications have been detected at 1006, process 1000 proceeds to 1008.

At 1008, the video conferencing application collects updated presentation data with the modifications to the slides from the presenter device. At 1010, the video conferencing application causes to encode, at the presenter device, the updated presentation data. At 1012, the video conferencing application transmits, to the receiver device, the encoded updated presentation data. At 1014, the video conferencing application causes to overlay, at the receiver device, the encoded updated presentation data over the stored presentation data. At 1016, the video conferencing application stores, in the buffer at the receiver device, the overlaid updated presentation data. At 1018, the video conferencing application monitors for a user selection at the presenter device to navigate to a modified slide. In some embodiments, at 1020, if a user selection has not been detected, process 1000 returns to 1018. In some embodiments, at 1020, if a user selection has been detected, process 1000 proceeds to 1022. At 1022, the video conferencing application causes to decode, at the receiver device, the overlaid updated presentation data stored in the buffer at the receiver device. At 1024 the video conferencing application causes to generate for display, at the receiver device, the decoded overlaid updated presentation data.

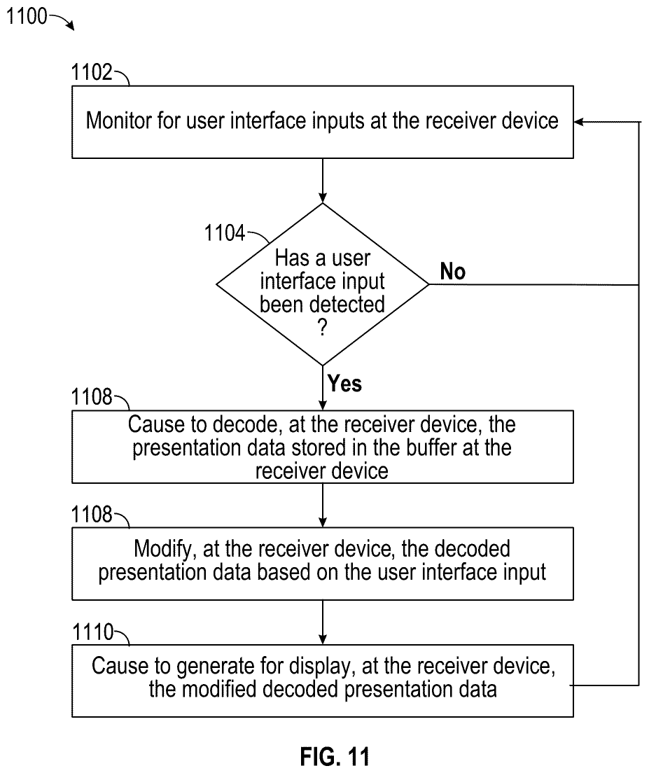

FIG. 11 is a flowchart of an illustrative process for improving presentation sharing in video conferencing when the presentation receiver is modifying the presentation, in accordance with some embodiments of the present disclosure. In various embodiments, the individual steps of process 1100 may be implemented by system 120 of FIG. 1B, for example, by the video conferencing application, or by using the control circuitry of presenter device 102 or receiver device 104. For example, non-transitory memories of one or more components of presenter device 102 or receiver device 104 or devices of FIGS. 8 and 9, e.g., storage 914 and control circuitry 911, may store instructions that, when executed by the control circuitry of presenter device 102 or receiver device 104 or devices of FIGS. 8 and 9 (as described further below with reference to FIGS. 8 and 9), cause execution of the process depicted in FIG. 11. The actions or descriptions of FIG. 11 may be used with any other embodiment of this disclosure. In addition, the actions and descriptions described in relation to FIG. 11 may be done in suitable alternative orders or in parallel to further the purposes of this disclosure.

In some embodiments, at 1102, the video conferencing application monitors for user inputs at the receiver device (e.g., receiver device 104 of FIG. 1B), e.g., a user of the receiver device zooming in on the presentation being shared. In some embodiments, at 1104, if a user interface input has not been detected, process 1100 returns to 1102. In some embodiments, at 1104, if a user interface input has been detected, process 1100 proceeds to 1106. At 1106, the video conferencing application causes to decode, at the receiver device, the presentation data stored in the buffer at the receiver device. At 1108, the video conferencing application modifies, at the receiver device, the decoded presentation data based on the user interface input at the receiver device. At 1110, the video conferencing application causes to generate for display, at the receiver device, the modified decoded presentation data. In some embodiments, the video conferencing application then returns to 1102.

The foregoing is merely illustrative of the principles of this disclosure and its various embodiments. Various modifications may be made by those skilled in the art without departing from the scope of this disclosure. The above-described embodiments are presented for purposes of illustration and not of limitation. The present disclosure also can take many forms other than those explicitly described herein. Accordingly, it is emphasized that this disclosure is not limited to the explicitly disclosed methods, systems, and apparatuses, but is intended to include variations and modifications thereof, which are within the spirit of the following claims.

1. A method comprising:
causing to generate for display, at a receiver device, shared content from a presenter device during a video conference, wherein the shared content comprises a first slide of a plurality of slides in a slide presentation;
collecting presentation data from the presenter device;
causing to encode, at the presenter device, the presentation data;
transmitting, to the receiver device, the encoded presentation data;
storing, in a buffer at the receiver device, the encoded presentation data; and
based at least in part on detecting a user interface input at the presenter device:
causing to decode the encoded presentation data stored in the buffer at the receiver device; and
causing to generate for display, at the receiver device, the decoded presentation data.

2. The method of claim 1, wherein the shared content is generated for display at the receiver device through a screen-sharing functionality of a video conferencing application hosting the video conference.

3. The method of claim 1, wherein the presentation data comprises image data corresponding to a second slide of the plurality of slides in the slide presentation, and wherein the user interface input at the presenter device is a user selection at the presenter device to navigate to the second slide of the plurality of slides in the slide presentation.

4. The method of claim 3, wherein the detecting the user interface input further comprises transmitting a signal to the receiver device to decode the encoded presentation data stored in the buffer at the receiver device and to generate for display the decoded presentation data.

5. The method of claim 3, further comprising:
causing to generate for display, at the receiver device, the second slide of the plurality of slides in the slide presentation;
collecting image data corresponding to a third slide of the plurality of slides in the slide presentation from the presenter device;
causing to encode, at the presenter device, the image data of the third slide;
transmitting, to the receiver device, the encoded image data from the third slide;
storing, in the buffer at the receiver device, the encoded image data from the third slide; and
based at least in part on detecting a user selection at the presenter device to navigate to the third slide:
causing to decode the encoded image data from the third slide stored in the buffer at the receiver device; and
causing to generate for display, at the receiver device, the decoded image data from the third slide.

6. The method of claim 3, wherein the presentation data comprising the image data corresponding to the second slide of the plurality of slides in the slide presentation comprises a bitstream of multiple frames of the second slide, and wherein the causing to encode, at the presenter device, the presentation data further comprises transcoding, at the presenter device, the multiple frames of the second slide to a single high-quality frame of the second slide.

7. The method of claim 6, further comprising replacing the bitstream of multiple frames of the second slide with the single high-quality frame of the second slide.

8. The method of claim 1, wherein the user interface input is a first user interface input, further comprising:
based at least in part on detecting a second user interface input at the presenter device, wherein the second user interface input comprises a user selection at the presenter device to modify a second slide of the plurality of slides in the slide presentation:
collecting updated presentation data from the presenter device, wherein the updated presentation data comprises image data corresponding to the modified second slide;
causing to encode, at the presenter device, the updated presentation data;
transmitting, to the receiver device, the encoded updated presentation data;
causing to compare, at the receiver device, the encoded updated presentation data with the encoded presentation data to determine a similarity measurement; and
based at least in part on determining, at the receiver device, that the similarity measurement is below a threshold value:
storing, in the buffer at the receiver device, the encoded updated presentation data; and
based at least in part on detecting a third user interface input at the presenter device, wherein the third user interface input at the presenter device is a user selection at the presenter device to navigate to the modified second slide:
causing to decode, at the receiver device, the encoded updated presentation data stored in the buffer at the receiver device; and
causing to generate for display, at the receiver device, the decoded updated presentation data.

9. The method of claim 8, wherein the encoded updated presentation data replaces the presentation data in the buffer at the receiver device.

10. The method of claim 9, further comprising:
causing to maintain, at the receiver device, the buffer to store the presentation data for a preset duration of time;
collecting updated presentation data from the presenter device, wherein the updated presentation data comprises modifications to the plurality of slides;
causing to encode, at the presenter device, the updated presentation data;
transmitting, to the receiver device, the encoded updated presentation data;
causing to overlay, at the receiver device, the encoded updated presentation data over the stored presentation data;
storing, in the buffer at the receiver device, the overlaid updated presentation data; and
based at least in part on detecting the second user interface input at the presenter device:
causing to decode, at the receiver device, the overlaid updated presentation data stored in the buffer at the receiver device; and
causing to generate for display, at the receiver device, the decoded overlaid updated presentation data.

11. (canceled)

12. The method of claim 1, wherein the collecting presentation data from the presenter device comprises:
detecting a shared window corresponding to the slide presentation at the presenter device; and
collecting image data corresponding to the plurality of slides in the slide presentation by capturing an image of each slide of the plurality of slides in the slide presentation.

13. The method of claim 12, wherein the collecting image data corresponding to the plurality of slides in the slide presentation by capturing the image of the each slide of the plurality of slides in the slide presentation further comprises:
while causing to generate for display, at the receiver device, the first slide of the plurality of slides:
capturing an image of a second slide of the plurality of slides; and
capturing an image of a third slide of the plurality of slides.

14. (canceled)

15. The method of claim 1, wherein the presentation data comprises image data corresponding to the plurality of slides in the slide presentation, and wherein the causing to encode, at the presenter device, the presentation data, comprises:
periodically causing insertion of instantaneous decoder refresh (IDR) frames for each slide of the plurality of slides in the slide presentation.

16. The method of claim 1, wherein the presentation data comprises image data corresponding to the plurality of slides in the slide presentation, and wherein the causing to encode, at the presenter device, the presentation data, comprises:
causing encoding an intra-coded (I) frame or IDR frame for each slide of the plurality of slides in the slide presentation; and
causing encoding predicted (P) frames and bidirectional (B) frames to signal changes made to the slide presentation at the presenter device.

17. The method of claim 1, wherein the presentation data comprises image data corresponding to the plurality of slides in the slide presentation, wherein the transmitting, to the receiver device, the encoded presentation data comprises transmitting image analysis information of the first slide to the receiver device, and wherein the causing to decode the encoded presentation data stored in the buffer at the receiver device comprises:
based at least in part on the image analysis information of the first slide:
causing retrieving an I frame or IDR frame for the first slide from the buffer at the receiver device.

18. The method of claim 1, wherein the presentation data comprises image data corresponding to the plurality of slides in the slide presentation, and wherein the causing to encode, at the presenter device, the presentation data, comprises:
causing to compare, at the presenter device; the first slide and a second slide of the plurality of slides to determine a similarity measurement; and
based at least in part on determining, at the presenter device, that the similarity measurement is below a threshold value:
causing inserting an I frame or an IDR frame at encoding the second slide of the plurality of slides.

19. The method of claim 1, wherein the presentation data comprises image data corresponding to the plurality of slides in the slide presentation, and wherein the causing to encode, at the presenter device, the presentation data, comprises:
causing to compare, at the presenter device; the first slide and a second slide of the plurality of slides to determine a similarity measurement; and
based at least in part on determining, at the presenter device, that the similarity measurement is above a threshold value:
causing encoding the second slide as a P frame or a B frame.

20. The method of claim 1, wherein the presentation data comprises image data corresponding to the plurality of slides in the slide presentation, and wherein the causing to encode, at the presenter device, the presentation data, comprises:
causing encoding a second slide of the plurality of slides to an IDR frame at a high bitrate; and
causing delivery of the IDR frame in a duration of multiple frames.

21. The method of claim 1, wherein the presentation data comprises image data corresponding to the plurality of slides in the slide presentation, and wherein the causing to encode, at the presenter device, the presentation data, comprises:
determining a number of slides of the plurality of slides; and
causing encoding a number of frames corresponding to the number of slides for transmission.

22. (canceled)

23. A system comprising:
control circuitry of a video conferencing application configured to:
cause to generate for display, at a receiver device, shared content from a presenter device during a video conference, wherein the shared content comprises a first slide of a plurality of slides in a slide presentation;
collect presentation data from the presenter device;
cause to encode, at the presenter device, the presentation data;
transmit, to the receiver device, the encoded presentation data;
store, in a buffer at the receiver device, the encoded presentation data; and
based at least in part on detecting, via input/output circuitry, a user interface input at the presenter device:
cause to decode the encoded presentation data stored in the buffer at the receiver device; and
cause to generate for display, at the receiver device, the decoded presentation data.

24.-110. (canceled)
